(19) United States
(12) Patent Application Publication
(10) Pub. No.: US 2025/0266789 A1
(43) Pub. Date: Aug. 21, 2025

(54) SUPPORTING STRUCTURE FOR PHOTOVOLTAIC PANELS

(71) Applicant: Krzysztof DORYNEK, Starogard Gdanski (PL)

(72) Inventor: Krzysztof DORYNEK, Starogard Gdanski (PL)

(21) Appl. No.: 18/859,318

(22) PCT Filed: Mar. 28, 2023
(86) PCT No.: PCT/PL2023/000018

§ 371 Date: Oct. 23, 2024

(30) Foreign Application Priority Data
Oct. 24, 2022 (PL) P.442609

(51) Int. Cl. H02S 20/30; F16M 13/02; H02S 30/10; H02S 40/22

(52) U.S. Cl. CPC H02S 20/30; F16M 13/02; H02S 30/10; H02S 40/22

(57) ABSTRACT

The subject of the solution is a supporting structure for photovoltaic panels contains brackets, a support beam, two columns. The supporting structure characterised in that, there are at least two brackets (1) no longer than a side wall (2) of the photovoltaic panel (3), fixed transversely and at a substantially central point on a support beam (10) extending the width of the support structure (12) and supported by two columns (13) embedded in the ground, wherein the bracket (1) is a thin-walled section of open profile and comprises at least one support wall (4) and a retaining wall (5) substantially perpendicular thereto, and the photovoltaic panel (3) is located on the support walls (4) of the two brackets (1), between their retaining walls (5), and the support wall (4) does not extend beyond the width (A) of a frame (7) of the photovoltaic panel (3).

The subject of the solution is a supporting structure for photovoltaic panels. The disclosed solution relates to a free-standing, ground-mounted supporting structure, in particular for double-sided photovoltaic panels.

Photovoltaic installations are currently regarded as a multi-year investment with an estimated payback of 6 to 10 years, where the lifetime of photovoltaic panels reaches up to 30 years. Photovoltaic panels still only utilise a small part of the sun's energy. Various solutions are being sought to increase the efficiency of the panels. A relatively new solution is bifacial modules, where both sides of the panel cells absorb sunlight. The other side of the panel acquires energy from reflected and diffused rays, so the mounting location becomes extremely important, as does the supporting structure, which contributes to reducing the access of light. Numerous studies have shown that, under reference conditions (panel without restricted light access) in an analogous position to a photovoltaic panel mounted on support structures, with a reflectance of 90%, the production of the back side of the module reaches 40% of the front side.

Known from the state of the art are free-standing supporting structures designed for double-sided panels.

Utility model CN213879701U discloses a solution for a supporting structure designed for double-sided panels. A beam with a square profile is attached to the columns at multiple support points. Attached to the beam are trusses supported by brackets additionally fastened to the beam. Above and below the beam, between the inclined supports, are the photovoltaic modules, the frame of which is fixed to the inclined supports.

The basic premise of supporting structures for double-sided solar panels, in addition to ensuring optimum solar exposure of the upper part of the panel, is to ensure the best possible access of sunlight to the opposite side of the panel and that none of the cells in the panel are shaded. The way solar cells work—their electrical connections in series, make all the solar cells in the area of one panel act as the weakest of them. However, it is not only shading that can affect the efficiency of a solar cell. The solar cell also adversely changes its performance with increasing temperature.

The developer of the solution in question observed that photovoltaic cells located in close proximity to supporting structures such as support beams have the lowest lifetime. With a minimum distance, air circulation remains impaired, and at high temperatures, the developer has observed a higher temperature of neighbouring photovoltaic cells relative to the temperature of the others, which is related to the thermal radiation of the support beam directed at the cells. Thus, it is the supporting structure that can contribute to a decrease in the lifetime of the photovoltaic panel.

The aim of the solution is therefore to provide a support structure for photovoltaic panels that has the advantages of the presented state of the art, but also solves its disadvantages regarding shading and the varying temperature of the individual cells due to the influence of the support structure on the cells.

According to the solution, a supporting structure for photovoltaic panels contains brackets, a support beam, two columns. The supporting structure characterised in that, there are at least two brackets no longer than a side wall of the photovoltaic panel, fixed transversely and at a substantially central point on a support beam extending the width of the support structure and supported by two columns embedded in the ground, wherein the bracket is a thin-walled section of open profile and comprises at least one support wall and a retaining wall substantially perpendicular thereto. The photovoltaic panel lies on the support walls of the two brackets, between their retaining walls, and the support wall does not extend beyond the width of a frame of the photovoltaic panel. The thin-walled bracket structure adjoining to the photovoltaic panel frames does not restrict light along the photovoltaic panel outline. Effectively, there is an increase in illumination of the outermost cells of up to 40% compared to panels supported by thick profiles along the sides. This increases the output of the back side of the photovoltaic panel by more than 50% and, as a result, the output of the entire panel by more than 10%.

Preferably, the frame of the photovoltaic panel is connected detachably by connecting means from underneath to the support walls of the brackets. Connections most often made by screws on the underside allow the use of brackets whose top edge does not extend beyond the top wall of the panel frame, so that more light is absorbed by the panel. The access of light to the top wall of the photovoltaic panel is unrestricted.

In another preferably solution option the frame of the photovoltaic panel is connected detachably by connecting means from the side to the retaining walls of the brackets. This allows the underside of the panel frame and the support wall of the bracket to be thinner and therefore has less impact on the shading of the panel.

Preferably, the bracket contains a top wall and a closing wall, where the top wall is substantially parallel to the support wall and is at most the width of the support wall, and the closing wall extends from the bottom edge of the support wall to the bottom edge of the retaining wall, and the photovoltaic panel is inserted between the top wall and the support wall of the two brackets and rests on the closing wall. The design allows the support of panels also without a frame, where the bracket forms a pocket into which the panel is inserted without the photovoltaic panel having to be bolted.

Preferably, the bracket is connected to an top wall and a closing wall, where the top wall is substantially parallel to the support wall and extends beyond the retaining wall no further than the support wall. The closing wall extends from the lower edge of the top wall towards the retaining wall. The photovoltaic panel is inserted between the top wall and the support wall of the two brackets and rests on the closing wall.

Preferably, the brackets are connected to the support beam via support parts and connecting means. Supporting parts can allow the structure's components to be moved away from the photovoltaic cells, which contributes to better light access to the panel in the area of the support beam and thus ensuring more uniform operation of the cells, resulting in a reduction in the amperage difference and an increase in panel life. Preferably, the support beam is fixed to the columns by means of an adjustment mechanism. The adjustment mechanism containing a movable part connected to the support beam and a position lock, the movable part being pivotally connected to the column, where the rotation axis is parallel to the support beam. An adjustment mechanism allows the tilt of the panel to be adjusted to the maximum height of the sun above the horizon, which varies throughout the year. The solution is designed for latitudes away from the tropics, where the efficiency of solar installations is lower and the investment in tracking systems does not pay off. The premise of the solution is to manually change the tilt of the panel several times a year according to the height of the sun above the horizon at a given time of the year.

Preferably, all elements of the support structure are white in colour with a rough surface. A white wall reflects light best, while a rough wall diffuses it. Uneven illumination through the accumulation of the light beam reflected from the supporting structure contributes to a decrease in efficiency and panel life.

Preferably, at the bottom of the columns, trims are fitted between which a reflector extends. Thanks to the use of a reflective element, more reflected rays reach the lower surface of the panel.

Preferably, the reflective element is a white tarpaulin or panel with a reflectivity of more than 40%.

The subject of the solution is illustrated with examples that do not limit its scope. The solution is illustrated in the figures:

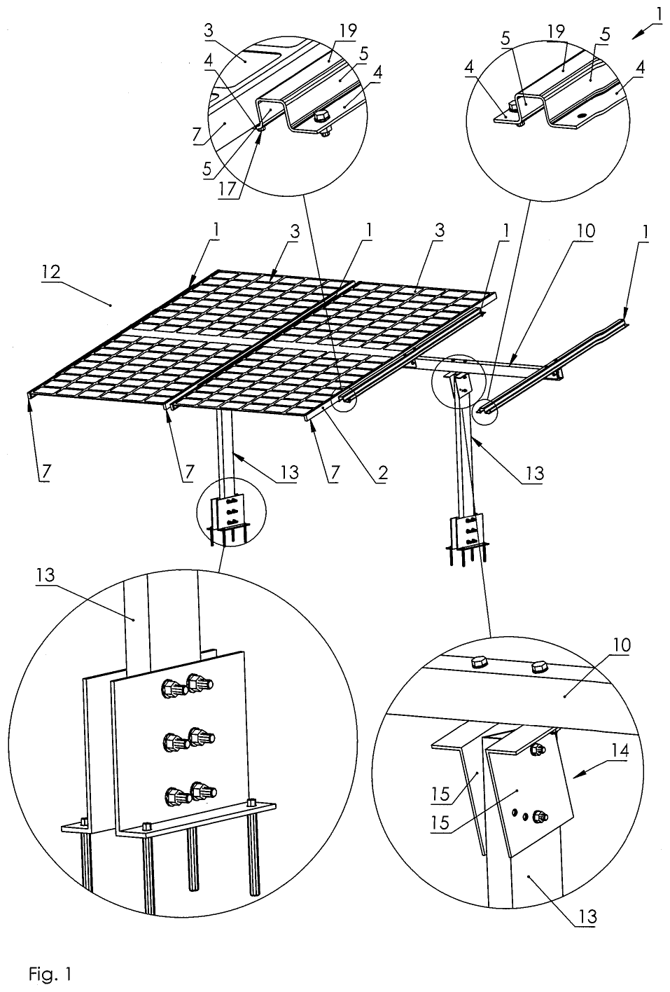

FIG. 1.—variant one of the supporting structure in axonometric view

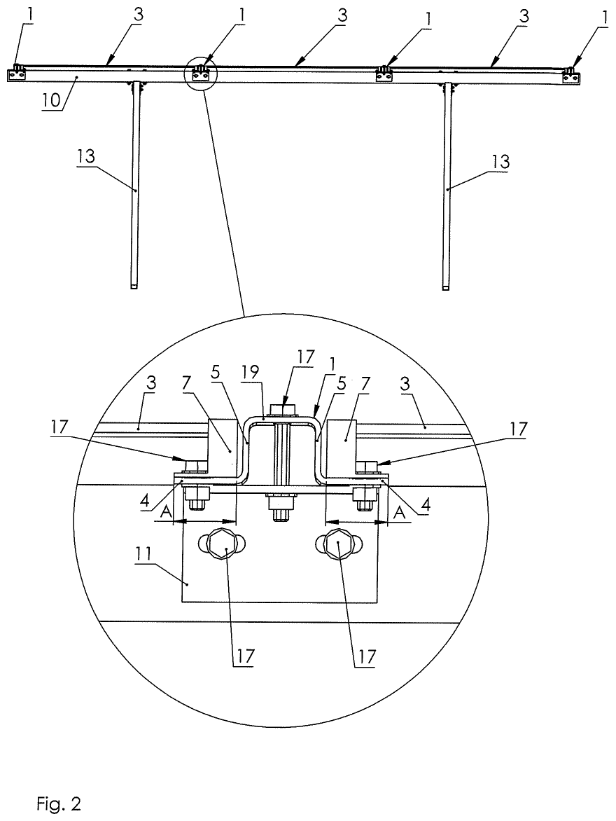

FIG. 2.—fixing the panel frame to the supporting wall of the bracket

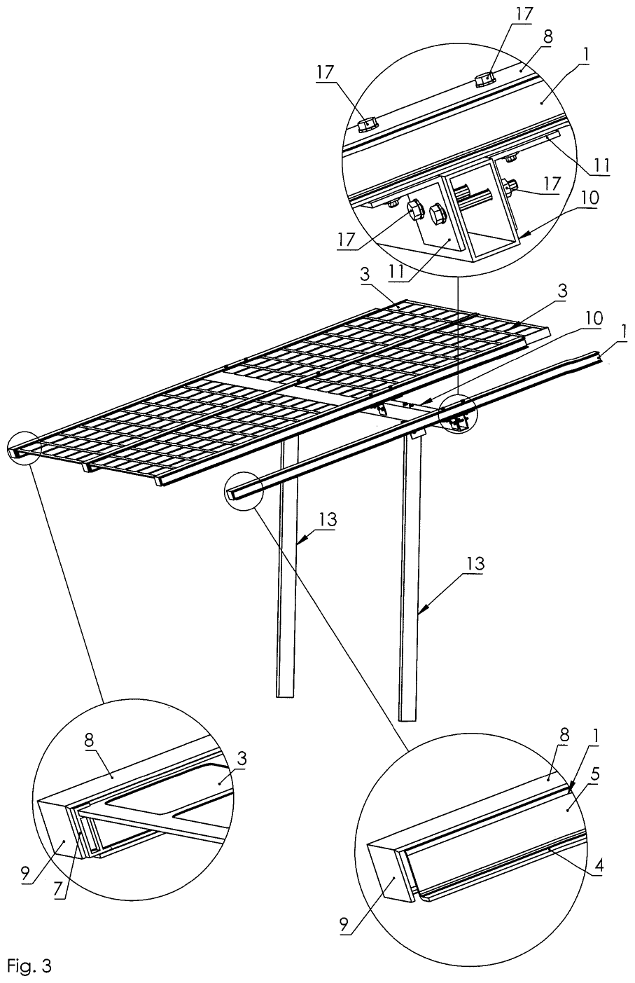

FIG. 3.—variant two of the supporting structure in axonometric view

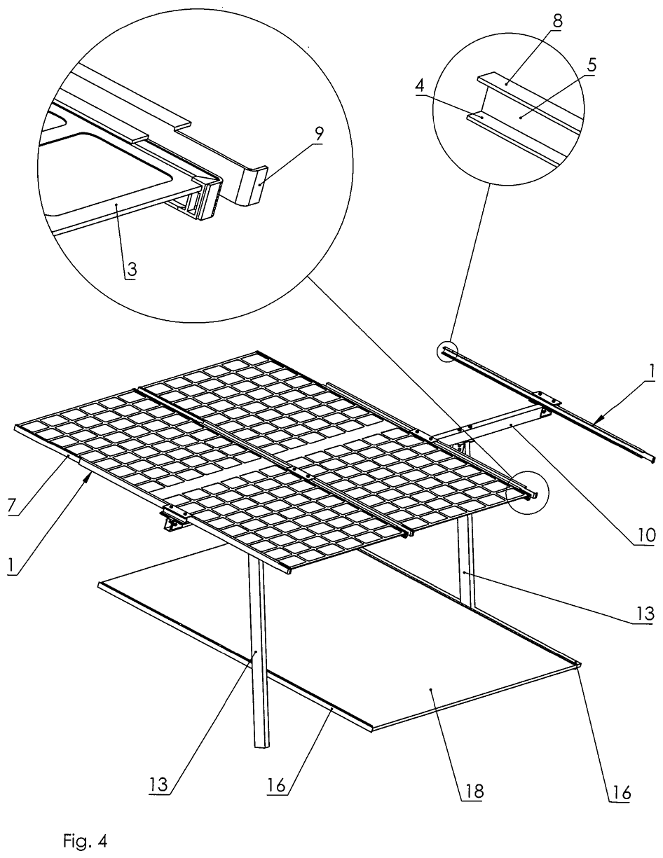

FIG. 4.—variant three of the supporting structure in axonometric view.

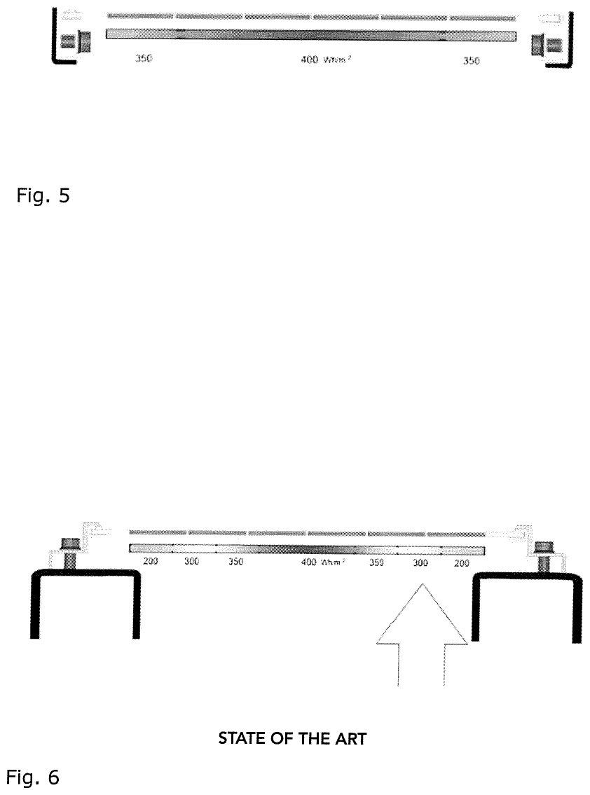

FIG. 5.—degree of illumination of the underside of the panel

FIG. 6.—state of the art: degree of illumination of the underside of the panel

FIG. 1 shows a first example of the implementation of a supporting structure for three photovoltaic panels contains four brackets 1, a support beam 10, two columns 13. The brackets 1 of length 60% of the side wall 2 of the photovoltaic panel 3 are fixed transversely and at a substantially central point on the support beam 10. The brackets 1 are thin-walled sections of open profile and contain two support walls 4 and substantially perpendicular retaining walls 5 connected by a connecting wall 19. The plane of the retaining walls 5 is substantially vertical and the support walls 4 of all the brackets 1 in the structure are in one plane. The two support walls 4 of the adjacent brackets are located between the retaining walls 5. The distance between the retaining walls 5 of adjacent brackets 1 is 2 mm greater than the width of the photovoltaic panel 3. Alternatively, this width can be greater than the width of the photovoltaic panel 3 by a maximum of 20 mm. The connection is made by means of two support parts 11 (angle brackets) screwed to opposite sides of the support beam 10 and with their upper surface screwed to the connecting wall 19 of the bracket 1 using connecting means 17 (standard screw connection elements), as shown in FIG. 2. The support beam 10 extends over the width of the support structure 12 and is supported by two columns 13 embedded in the ground (anchoring to the ground). The height of the retaining wall does not exceed the height of the photovoltaic panel frame. The photovoltaic panels 3 are located on the support walls 4 of two adjacent brackets 1, between their retaining walls 5. The support wall 4 does not extend beyond the width A of the frame 7 of the photovoltaic panel 3.

In the first example of implementation, the frame 7 of the photovoltaic panel 3 is detachably connected by means of connecting means 17, which are elements of the screw connection, to the brackets 1. In FIG. 2 shows a cross-section of the bracket 1 disclosing the attachment from underneath to the support wall 4 of the bracket 1.

The support beam 10 is fixed to the columns 13 via an adjusting mechanism 14 containing a movable part 15 connected to the support beam 10 and a position lock. The movable part 15 is pivotally connected to the column 13, where the axis of rotation is parallel to the support beam 10. The position lock is implemented by means of two screw connections and adjustment holes in the movable part 15, where the adjustment mechanism allows the support beam 10 to rotate about the axis of the upper screw connection (axis of rotation) and the lower screw connection serves as a position lock, which position is changed depending on the hole selected in the movable part 15.

In a further example of implementation shown in FIG. 3, the bracket 1 is connected to a top wall 8 and a closing wall 9 formed of a single bent sheet. The top wall 8 is substantially parallel to the support wall 4 and extends beyond the retaining wall 5 no further than the support wall 4. It lies on the connecting wall 19 and is bolted to it. The closing wall 9 extends from the lower edge of the upper wall 8 towards the retaining wall 5—it is perpendicular to it. The example shows a structure adapted for three photovoltaic panels 3, two are sandwiched between the top wall 8 and the support wall 4 of the adjacent brackets 1 and rest with the lower part of the frame 7 on the closing wall 9.

In another example of implementation shown in FIG. 4 the structure differs from the first example in that there are six brackets 1, which each contain a support wall 4 and a retaining wall 5, a top wall 8 and a closing wall 9. The top wall 8 is substantially parallel to the support wall 4 and is the width of the support wall 4, and the closing wall 9 extends from the bottom edge of the retaining wall 5 to the width of the support wall 4. The photovoltaic panel 3 is inserted between the top wall 8 and the support wall 4 of two brackets 1 and rests on the closing wall 9. The brackets 1 are connected to the support beam 10 by means of support parts 11 and connecting means 17. At the lower part of the columns 13, trim 16 is mounted between which extends a reflecting element 18 which is a white tarpaulin or board with a reflectivity of more than 40%.

FIGS. 5 and 6 show the degree of illumination of the underside of the photovoltaic panel at identical exposure for brackets compatible with the proposed supporting structure (FIG. 5) and for brackets known from the state of the art, where the dimension of the profile supporting the panel frame significantly exceeds it. In extreme cases, the power of the underside drops by up to more than 50%, as a result of the shading of the extreme cells by the brackets, and these, connected in series in the installation, limit the power of the other cells.

1. A supporting structure for photovoltaic panels contains brackets, a support beam, two columns
characterised in that,
there are at least two brackets no longer than a side wall of the photovoltaic panel, fixed transversely and at a substantially central point on a support beam extending the width of the support structure and supported by two columns embedded in the ground, wherein the bracket is a thin-walled section of open profile and comprises at least one support wall and a retaining wall substantially perpendicular thereto, and the photovoltaic panel is located on the support walls of the two brackets, between their retaining walls, and the support wall does not extend beyond the width of a frame of the photovoltaic panel.

2. The supporting structure according to claim 1, wherein the frame of the photovoltaic panel is connected detachably by connecting means from underneath to the support walls of the brackets.

3. The supporting structure according to claim 1, wherein the frame of the photovoltaic panel is connected detachably by connecting means from the side to the retaining walls of the brackets.

4. The supporting structure according to claim 1, wherein the bracket contains a top wall and a closing wall, where the top wall is substantially parallel to the support wall and is at most the width of the support wall, and the closing wall extends from the bottom edge of the support wall to the bottom edge of the retaining wall, and the photovoltaic panel is inserted between the top wall and the support wall of the two brackets and rests on the closing wall.

5. The supporting structure according to claim 1, wherein the bracket is connected to an top wall and a closing wall, where the top wall is substantially parallel to the support wall and extends beyond the retaining wall no further than the support wall, and the closing wall extends from the lower edge of the top wall towards the retaining wall, and the photovoltaic panel is inserted between the top wall and the support wall of the two brackets and rests on the closing wall.

6. The supporting structure according to claim 1, wherein the brackets are connected to the support beam via support parts and connecting means.

7. The supporting structure according to claim 1, wherein the support beam is fixed to the columns by means of an adjustment mechanism containing a movable part connected to the support beam and a position lock, the movable part being pivotally connected to the column, where the rotation axis is parallel to the support beam.

8. The supporting structure according to claim 1, wherein all elements of the support structure are white in colour with a rough surface.

9. The supporting structure according to claim 1, wherein at the bottom of the columns, trims are fitted between which a reflective element extends.

10. The supporting structure according to claim 9, wherein the reflective element is a white tarpaulin or panel with a reflectivity of more than 40%.

11. The supporting structure according to claim 2, wherein the brackets are connected to the support beam via support parts and connecting means.

12. The supporting structure according to claim 3, wherein the brackets are connected to the support beam via support parts and connecting means.

13. The supporting structure according to claim 4, wherein the brackets are connected to the support beam via support parts and connecting means.

14. The supporting structure according to claim 5, wherein the brackets are connected to the support beam via support parts and connecting means.

15. The supporting structure according to claim 2, wherein the support beam is fixed to the columns by means of an adjustment mechanism containing a movable part connected to the support beam and a position lock, the movable part being pivotally connected to the column, where the rotation axis is parallel to the support beam.

16. The supporting structure according to claim 3, wherein the support beam is fixed to the columns by means of an adjustment mechanism containing a movable part connected to the support beam and a position lock, the movable part being pivotally connected to the column, where the rotation axis is parallel to the support beam.

17. The supporting structure according to claim 4, wherein the support beam is fixed to the columns by means of an adjustment mechanism containing a movable part connected to the support beam and a position lock, the movable part being pivotally connected to the column, where the rotation axis is parallel to the support beam.

18. The supporting structure according to claim 5, wherein the support beam is fixed to the columns by means of an adjustment mechanism containing a movable part connected to the support beam and a position lock, the movable part being pivotally connected to the column, where the rotation axis is parallel to the support beam.

19. The supporting structure according to claim 2, wherein all elements of the support structure are white in colour with a rough surface.

20. The supporting structure according to claim 2, wherein at the bottom of the columns, trims are fitted between which a reflector elements extends.
